(19) United States
(12) Patent Application Publication
(10) Pub. No.: US 2025/0067693 A1
(43) Pub. Date: Feb. 27, 2025

(54) SENSOR FOR THEMAL PROPERTIES MEASUMENT USING THE 3 OMEGA METHOD AND METHODS OF USE THEREOF

(71) Applicant: The Regents of the University of California, Oakland, CA (US)

(72) Inventors: Divya Chalise, Berkeley, CA (US); Richard Tee, Cerritos, CA (US); Yuqiang Zeng, Berkeley, CA (US); Sumanjeet Kaur, Pinole, CA (US); Ravi S. Prasher, Danville, CA (US)

(21) Appl. No.: 18/810,829

(22) Filed: Aug. 21, 2024

Related U.S. Application Data
(60) Provisional application No. 63/578,193, filed on Aug. 23, 2023.

(51) Int. Cl. G01N 25/18; G01B 7/06

(52) U.S. Cl. CPC G01N 25/18; G01B 7/06

(57) ABSTRACT

This disclosure provides systems, methods, and apparatus related to thermal properties measurement. In one aspect, a method includes providing a sensor. The sensor comprises a polymer film a metal line disposed on the polymer film. Each end of the metal line is a contact pad. A thermal interface material is deposited on a first sample. The sensor is placed on the thermal interface material. A pressure is applied to the sensor. Thermal conductivity of the first sample or thermal resistance of an interface between the first sample and a second sample is measured with the sensor using a 3 omega method.

### RELATED APPLICATIONS

This application claims priority to U.S. Provisional Patent Application No. 63/578,193, filed Aug. 23, 2023, which is herein incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### BACKGROUND

The 3 omega (3ω) method is a well-established frequency-domain thermal property measurement technique that has been used to measure the thermal conductivity of bulk materials and thin films and the thermal resistance of interfaces. This method has also been modified for non-conventional uses such as gas sensing and fouling thickness measurement. Recently, 3ω sensors embedded in batteries have been used to measure lithium distribution in electrodes and lithium deposition morphology at the lithium metal-solid state electrolyte interface.

The 3ω method has numerous advantages compared to traditional methods for thermal conductivity measurement. Steady state thermal conductivity measurement methods, such as the cut-bar method and the heat flow meter-based methods, measure the overall thermal resistance of the sample and the interfaces between the sample and the sensors. The interface resistance is assumed to be constant across multiple measurements, and the total thermal resistance of samples of different thicknesses is used to extract the thermal conductivity of the sample. If the sample thermal resistance is small compared to the interface thermal resistance, a small discrepancy in the interface resistance across the measurements can lead to a significant error in the extracted thermal conductivity. Unlike the steady state methods, the 3ω method is a frequency domain technique with a frequency dependent thermal penetration depth, which allows spatially resolved thermal measurement of multiple layers and interfaces beneath the sensor. This spatial resolution allows the decoupling of the interface resistance between the sensor and the substrate from the thermal properties of the substrate, allowing independent thermal interface resistance and thermal conductivity measurements without ambiguity. Unlike other transient methods such as a transient planar source (TPS) and the laser-flash method (LFM), which are limited to bulk samples, and time-domain thermoreflectance (TDTR), which is limited to thin films and/or high thermal conductivity samples, the 3ω method can measure a wide range of thermal conductivity across samples of various dimensions (from a few micrometers to bulk). Further, by varying the sensor geometry, the 3ω measurements can be made selectively sensitive to in-plane or cross-plane thermal conductivity, allowing independent measurement of the anisotropic thermal conductivity tensor in anisotropic samples.

Despite the numerous advantages, high-throughput spatially resolved 3ω measurements with reusable sensors have not been realized, and wide-scale adoption of the 3ω method has been severely limited. Traditionally, 3ω sensors are deposited on the samples. This requires the sample surface to be nominally planar with an average roughness of the order of less than a micrometer, as the sensor thickness is of the order of 100 nanometers. Moreover, the sensors deposited on one sample cannot be reused on other samples. Even though earlier work has reported reusable and attachable 3ω sensors, the thermal interface resistance between the sample and the sensor in those experiments was rather large, and since this thermal interface resistance dominates the 3ω signal, the method reported is not sensitive enough for spatially resolved thermal measurements or high thermal conductivity measurements. Therefore, the measurements are limited to low thermal conductivity samples (e.g., human skin). Further, for metallic substrates, an additional dielectric layer needs to be deposited between the sensor and the metallic substrate to electrically isolate the sensor from the metal substrate, requiring an additional step in sample preparation for 3ω measurements.

### SUMMARY

Here, we describe a method of using reusable 3ω sensors fabricated on polyimide films for high-throughput thermal measurements. We use a high thermal conductivity (k) thermal paste under a considerable (e.g., about 30 psi) external pressure to act as an intermediate layer between the sensor and the sample to minimize the interfacial thermal resistance and allow high thermal conductivity measurements. The same thermal paste acts as a dielectric film to isolate the sensor from metallic substrates, allowing 3ω measurement of metallic samples without any additional surface modification. This method eliminates the shortcomings of the general 3ω method discussed earlier, thereby enabling the potential for wide-scale application of the 3ω method for high-throughput thermal measurements.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows an example of 3ω sensors fabricated on a polyimide film. Each polyimide film contains two sensors, one inner and one outer, to allow for the measurement of samples of different sizes. The connection pads are fabricated away from the sensor to enable the application of high pressure on the sample/sensor stack. FIG. 1B shows an example of a typical measurement stack with the sensor and the thermal grease sandwiched between the sample and a rigid insulation layer (typically wood) at high external pressure.

FIG. 2A shows 3ω fits to determine the thermal conductivity of the thermal paste. From the measurement, the thermal conductivity was determined to be 7 W/m−K. FIG. 2B shows specific heat capacity of the thermal paste plotted as a function of temperature measured using differential scanning calorimetry (DSC). The room temperature (25° C.) specific heat capacity of the thermal grease is 770 J/kg−K.

FIG. 3 shows paste thickness plotted as a function of pressure in psi. The circles represent the experimental measurement, and the dotted-line is an empirical exponential best-fit.

FIGS. 4A-4D show 3ω measurements (circles) along with the best-fit lines (dashes) to determine the thermal conductivities of glass (FIG. 4A), steel (FIG. 4B), MgO (FIG. 4C), and p-doped silicon (FIG. 4D). The high frequency signal (˜10 Hz to 300 Hz) with a shorter penetration depth is used to fit the thickness of the paste, whereas the low frequency signal (<10 Hz) is used to fit the sample thermal conductivity.

FIGS. 5A-5D show plots showing measurement sensitivity as a function of frequency for the two fitting parameters (paste thickness and sample thermal conductivity) for glass (FIG. 5A), steel (FIG. 5B), MgO (FIG. 5C), and p-doped silicon (FIG. 5D). The high frequency signal (10 Hz-300 Hz) is exclusively sensitive to the paste thickness and is, therefore, used for obtaining the paste thickness. At lower frequencies (0.1 Hz to 10 Hz), the measurement is sensitive to the sample's thermal conductivity and can, therefore, be used to extract the sample thermal conductivity.

FIG. 6A shows the maximum measurement sensitivity to the sample thermal conductivity plotted as a function of the sample thermal conductivity. For samples with very low thermal conductivity, the heat loss to the insulation layer becomes significant, and the measurement sensitivity is compromised. The optimal measurement sensitivity is obtained for a sample thermal conductivity of ˜5 W/m−K, after which the measurement sensitivity decreases monotonically as the grease thermal resistance becomes dominant. For reliable measurements, we set the cutoff sensitivity to 0.1, corresponding to the sample thermal conductivity of 200 W/m−K, which is the measurement limit with this method. FIG. 6B shows a comparison of the thermal conductivity measured from standard methods to the thermal conductivity measured using the approach described in this work. Within the measurement limit, the obtained thermal conductivities agree well with the standard measurements.

FIG. 7A shows a setup to measure the thermal resistance of the interlayer thermal grease from 3ω measurements using the sensor. The thermal grease is sandwiched between a 10 μm copper film and a 670 μm thick silicon wafer. The same setup with the sensor and thermal grease with a rigid insulation layer on top is used to perform the 3ω measurements. FIG. 7B shows the interlayer thermal resistance measured from the 3ω method compared to the thermal resistance calculated from the grease thickness obtained from the micrometer measurement. The thermal resistance obtained from the 3ω measurements is within the range of that obtained from the micrometer measurements, and the qualitative trend of the monotonic decrease below 30 psi and saturation above 30 psi is evident.

FIGS. 8A-8D show 3ω measurements (circles) along with the best fit (dashed) curves to extract the interlayer thickness (d₂) at 3 psi (FIG. 8A), 12.5 psi (FIG. 8B), 25 psi (FIG. 8C), and 37.5 psi (FIG. 8D) stack pressure. FIGS. 8E-8H show the respective measurement sensitivities to the thickness (d₁) of the thermal paste between the stack and the sensor and the interlayer thickness (d₂) between copper and silicon. As the stack pressure increases, the paste thickness (d₁) and the sensitivity to the first layer of the thermal paste decreases, and the measurement sensitivity to the second layer of the thermal paste (d₂) increases.

FIG. 9 shows an example of a flow diagram illustrating a method for measuring the thermal properties of a sample.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

The 3-omega method is a technique used to measure the thermal conductivity of materials. It involves applying an oscillating electrical current to a metal strip disposed on a surface of a sample (generally, the metal strip is deposited on the surface of the sample). The oscillating electrical current generates a temperature oscillation in the sample. The temperature oscillation is then measured using resistance thermometry with the same metal strip that is used to apply the oscillating electrical current.

When a current at a frequency ω (or 1ω) is passed through a metal strip, due to Joule (Ohmic) heating in the metal strip with resistance R, the Joule heat produced (i.e., I²R) oscillates at frequency 2ω. This 2ω heat propagates into the sample according to the thermal properties of the sample. The Joule heat causes a temperature rise of T2ω, which also oscillates at the frequency 2ω. Due to linear temperature coefficient of resistance, this 2ω temperature rise causes resistance oscillations (R2ω) at the same frequency 2ω.

The voltage measured across the wire is the product of the current (oscillating at 1ω) and the resistance (oscillating at 2ω), resulting in a voltage that oscillates at a frequency of 3ω (i.e., V3ω). Thus, the voltage V3ω signal includes the temperature rise information (T2ω), which in turn includes the thermal properties (i.e., thermal conductivity and the specific heat) of the sample. From the measured 3 omega voltage, the thermal properties of the sample can calculated.

Further information regarding the implementation of and the calculations involved

with the 3 omega method can be found in the following papers, all of which are hereby incorporated by reference: M. L. Bauer and P. M. Norris, “General bidirectional thermal characterization via the 3ω technique,” Rev. Sci. Instrum. 85(6), 064903 (2014); D. G. Cahill, “Thermal conductivity measurement from 30 to 750 K: the 3ω method,” Rev. Sci. Instrum. 61, 802-808 (1990); S. D. Lubner, S. Kaur, Y. Fu, V. Battaglia, and R. S. Prasher, “Identification and characterization of the dominant thermal resistance in lithium-ion batteries using operando 3-omega sensors,” J. Appl. Phys. 127(10), 105104 (2020); and C. Dames, “MEASURING THE THERMAL CONDUCTIVITY OF THIN FILMS: 3 OMEGA AND RELATED ELECTROTHERMAL METHODS,” Annual Review of Heat Transfer, vol 16, pp. 7-49 (2013).

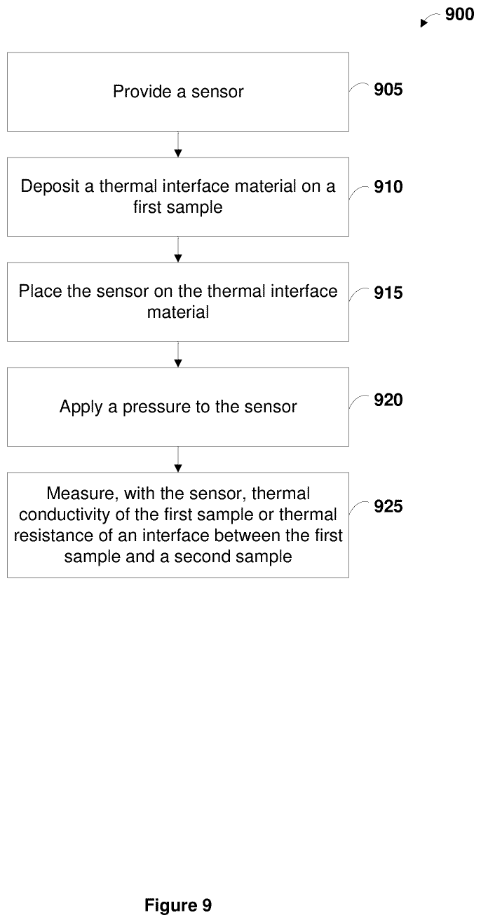

FIG. 9 shows an example of a flow diagram illustrating a method for measuring the thermal properties of a sample. Starting at block 905 of the method 900 shown in FIG. 9, a sensor is provided. The sensor comprises a polymer film and a metal line disposed on the polymer film, with each end of the metal line being a contact pad.

In some embodiments, the polymer film is a polymer from a group polyimide, polyvinylidene fluoride (PVDF), polyethylene (PE), and polytetrafluoroethylene (PTFE). In some embodiments, the polymer film is about 10 microns to 40 microns thick, or about 25 microns thick.

In some embodiments, the metal line is an alloy from a group chromium gold (Cr/Au), chromium silver (Cr/Ag), and chromium platinum (CR/Pt). In some embodiments, the metal line is about 50 microns to 150 microns thick, or about 110 microns thick. In some embodiments, the metal line is about 30 microns to 450 microns wide, about 100 microns to 450 microns wide, about 300 microns wide, or about 200 microns wide.

In some embodiments, the metal line comprises an elongated U-shape. Each point at the top of the U-shape comprises a contact pad. In some embodiments, a distance from a top of the U-shape to the bottom of the U-shape is about 1 inch to 5 inches, or about 1 inch to 3 inches.

At block 910, a thermal interface material is deposited on a first sample. The thermal interface material is operable to decrease a contact resistance between the first sample and the sensor. In some embodiments, the thermal interface material comprises a thermal paste or a thermal grease. In some embodiments, a thermal conductivity of the thermal interface material is at least about 4 watts per meter Kelvin (W/m−K).

In some embodiments, the first sample is metal. The thermal interface material and the polymer film are non-electrically conductive elements between the metal line of the sensor and the metallic sample. These non-electrically conductive elements allow for the 3 omega method to be used on metal samples.

At block 915, the sensor is placed on the thermal interface material.

At block 920, a pressure is applied to the sensor. In some embodiments, the pressure is about 15 psi to 45 psi, or about 30 psi. In some embodiments, after applying the pressure to the sensor, a thickness of the thermal interface material is substantially uniform. In some embodiments, after applying the pressure to the sensor, a thickness of the thermal interface material is about 15 microns to 60 microns, or about 30 microns.

At block 925, thermal conductivity of the first sample is measured or thermal resistance of an interface between the first sample and a second sample is measured using the 3 omega method. Note that thermal resistance is the reciprocal of thermal conductivity. In some embodiments, a lock-in amplifier and a current source in contact with the contact pads to perform the 3 omega method.

In some embodiments, measuring the thermal conductivity of the sample includes determining a thickness of the thermal interface material using the 3 omega method and then determining the thermal conductivity of the sample. The thermal conductivity of the thermal interface material is known. Performing the 3 omega method includes modulating a current passing through the sensor at 0.1 Hz to 300 Hz. A V_{3ω} signal measured with the sensor at about 0.1 Hz to 10 Hz (e.g., less than about 10 Hz) is used to determine a thickness of the thermal interface material. The V_{3ω} signal measured with the sensor at about 10 Hz to 300 Hz is used to determine a thickness of the thermal interface material.

In some embodiments, when the first sample is disposed on the second sample, the thermal conductivities of both the first sample and the second sample are known. In this instance, the thermal resistance of the interface between the first sample and the second sample is determined.

The sensor in the method 900 is not printed on a sample, as is often done when performing the 3 omega method. Because the sensor is not printed on the sample, the sensor can be used for further measurements using the 3 omega method.

For example, in some embodiments, the sample further comprises removing the sensor from the first sample. The thermal interface material is deposited on a third sample. The thermal interface material is operable to decrease a contact resistance between the third sample and the sensor. The sensor is placed on the thermal interface material. The pressure is applied to the sensor. Thermal conductivity of the third sample is measured or thermal resistance of an interface between the third sample and a fourth sample is measured using the 3 omega method. In some embodiments, a lock-in amplifier and a current source in contact with the contact pads to perform the 3 omega method.

The following examples are intended to be examples of the embodiments disclosed herein, and are not intended to be limiting.

### EXAMPLE

### Sensor Design and Fabrication, and 3ω Instrumentation

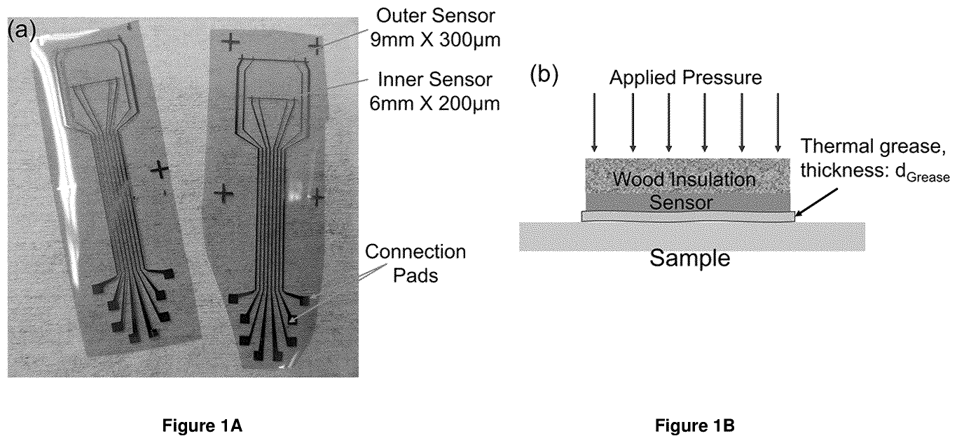

3ω sensors were fabricated on 25 μm polyimide film (Kapton, E. I. du Pont de Nemours and Company, Wilmington, Delaware) by depositing 100 nm gold with a 10 nm chromium adhesion layer (e-beam evaporation) through a custom shadow mask. Two sensors (shown in FIG. 1A) with different sensor lengths and half-widths were fabricated on the same film to allow measuring different sample sizes. The outer sensor was 9 mm long and 300 μm wide, while the inner sensor was 6 mm long and 200 μm wide. The connection pads for electrical connections to each sensor were fabricated away from the sensor to allow for the application of high pressure on the sensor/sample stack without breaking the electrical connections. Insulated copper wires were connected to the connection pads using silver-infused epoxy. The temperature coefficient of resistance (TCR) was calibrated for each sensor by measuring the 4-point resistance with a digital multimeter at temperatures between 25° C. and 40° C. The 3ω voltage across the sensor was measured using a lock-in amplifier, and the 1ω AC current passing through the sensor was supplied using a current source. Additionally, a custom circuit was employed to cancel the lo voltage originating from the sensor resistance.

### EXAMPLE

### Measurement Procedure

X23-7783D thermal paste (shin-Etsu MicroSi, Inc., Phoenix, AZ) was applied at ˜30 psi stack pressure between the sample and the 3ω sensor fabricated on the polyimide film to minimize the contact resistance between the sensor and the sample. First, ˜250 mg to 350 mg of thermal grease was applied to the sample to ensure full coverage of the thermal paste over an area of more than 1 in². Then the 3ω heater line was stacked on top of the grease, and a 1 in² wooden insulation block was stacked on top of the 3ω sensor, forming a stack of insulation, a 3ω sensor on polyimide, thermal grease, and the sample (shown in FIG. 1B). The thermal conductivity of the wooden insulation was assumed to be 0.2 W/m−K for all the measurements, but varied between 0.1 W/m−K and 0.4 W/m−K for uncertainty calculations. Using a pressure clamp, ˜30 lbs. of pressure was applied to the stack to ensure contact and thinning of the thermal grease layer to about 30 μm-50 μm. While doing so, it was ensured that there was no tilt of the wood insulation, which could affect the uniformity of the grease thickness. The 3ω measurement was performed using a custom LabVIEW program (National Instruments, Austin, TX) with the instrumentation described earlier. For each frequency in the 3ω measurement, the demodulated signal from the lock-in amplifier was sampled at a sampling rate of 4 Hz and was averaged for a sampling time of 60 s. All the 3ω measurements were performed in the frequency range of 0.1-310 Hz.

### EXAMPLE

### Paste Thermal Characterization

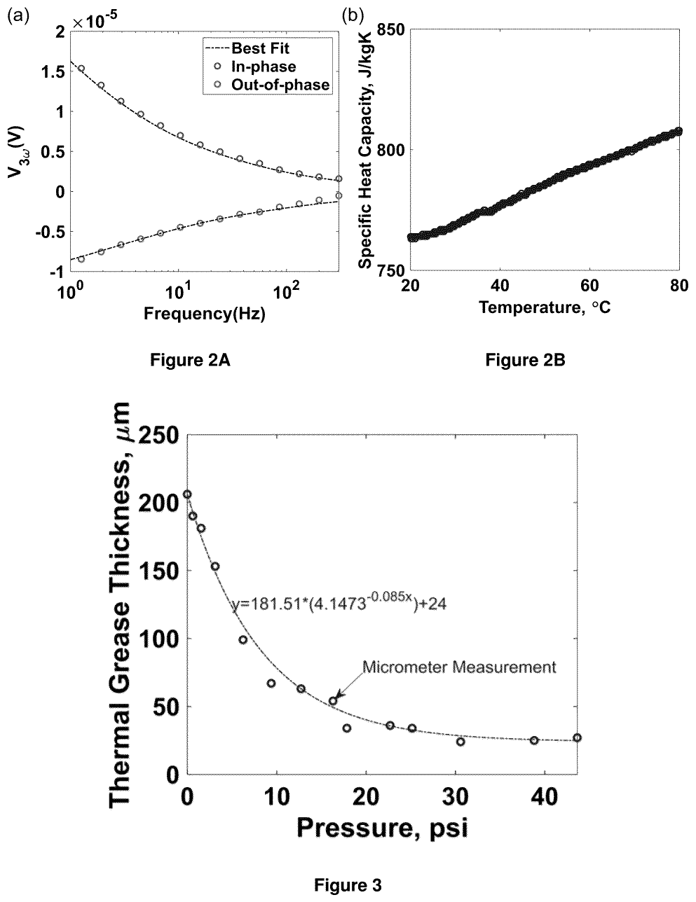

The specific heat capacity of the thermal interface paste was measured by differential scanning calorimetry (DSC) by direct heat flow measurement calibrated against a sapphire reference. The temperature was equilibrated at 10° C. for 5 min and ramped to 80° C. at 10° C./min. The specific heat capacity measured as a function of temperature is shown in FIG. 2B. The average specific heat capacity at room temperature was determined to be 770 J/kg−K. The density measurement was calculated from mass and volume measurements, rendering the room temperature volumetric heat capacity to be 1.87 MJ/m³K. The thermal conductivity of the paste was determined using the 3ω method. A 3ω sensor was deposited on a glass slide of known thermal conductivity, and the thermal paste was squeezed at 30 psi pressure between two glass slides with the sensor on one of them. The 3ω measurement was carried out between 1 Hz and 310 Hz. From the best-fit to the 3ω data (shown in FIG. 2A), the thermal conductivity of the thermal paste at room temperature was determined to be 7 W/m−K.

### EXAMPLE

### Thermal Paste Thickness Measurement

To characterize the thickness of the thermal paste as a function of stack pressure, the high thermal conductivity paste was sandwiched between two silicon wafers of known thickness and a 1×1 in² cross section. The pressure of the sandwiched stack was varied by a clamp and measured using a calibrated piezoelectric pressure-sensor described in D. Chalise et al., “Using thermal interface resistance for non-invasive operando mapping of buried interfacial lithium morphology in-solid state batteries,” ACS Appl. Mater. Interf. 15(13), 17344-17352 (2022), which is hereby incorporated by reference. The thickness was measured using a digital micrometer with a resolution of 1 μm to quantify the thickness of the paste as a function of stack pressure. The measured thickness as a function of the stack pressure along with the best-fit curve is shown in FIG. 3.

### EXAMPLE

### Standard Thermal Conductivity Measurements

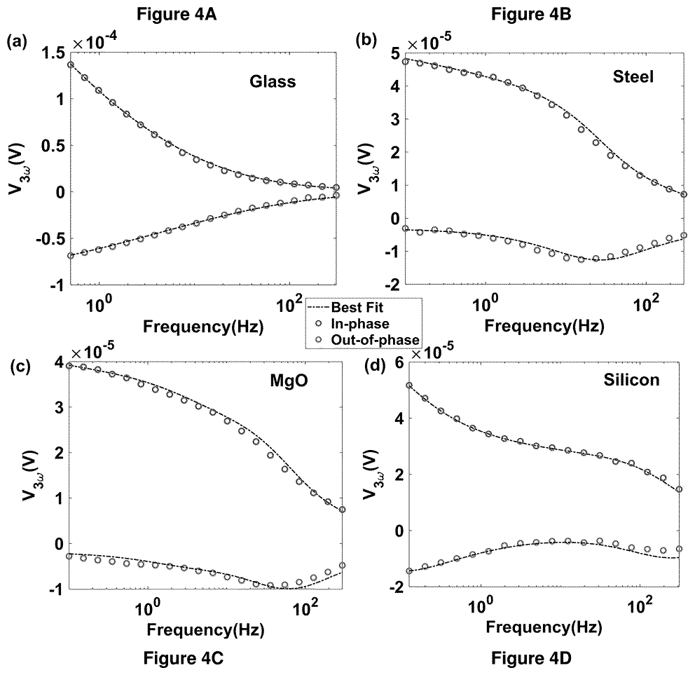

Thermal conductivity measurements of standard materials with a range of thermal conductivities were conducted to validate the measurement method and establish an upper limit for the thermal conductivity measurement. We measured the thermal conductivities of fused silica, magnesium oxide (MgO), steel (ASTM A108, 0.5% carbon), and doped silicon with the method and compared them against thermal conductivities obtained from standard 3ω measurement with sensors deposited on the sample (except steel, whose standard thermal conductivity was obtained from the literature). The 3ω fits for the standard measurements are shown in FIGS. 4A-4D. From the best fit, the obtained thermal conductivities are shown in Table I along with the standard thermal conductivities.

TABLE I
Comparison of the measured and standard
thermal conductivities of samples.

| | Measured | Standard |
|---|---|---|
| | thermal | thermal |
| | conductivity | conductivity |
| Material | (W/m-K) | (W/m-K) |
| Glass | 1.09 ± 0.15 | 1.18 |
| MgO | 45.8 ± 2.0 | 50 |
| Steel | 42.6 ± 3.5 | 40 |
| (ASTM | | |
| A108, 0.5% | | |
| carbon) | | |
| p-doped | 122.03 ± 4.7 | 120 |
| silicon | | |

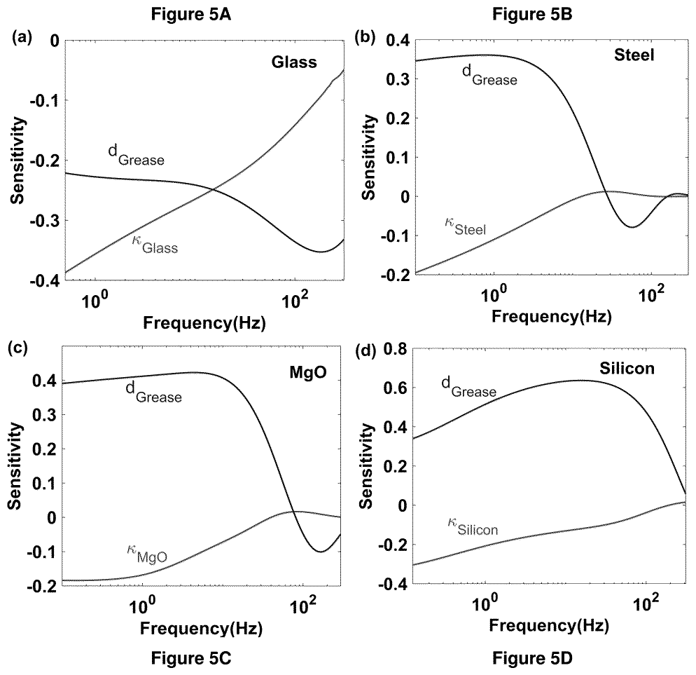

The measurement sensitivity (Sₚ) to a measurement parameter “p” is the percentage change in the signal for a percentage change in the parameter. It can be defined as

$${S}_{p} = \frac{dln ( {V}_{3 ω} )}{dln ( p )} = \frac{p}{{V}_{3 ω}} \frac{{dV}_{3 ω}}{dp} ,$$

where V_{3ω} is the magnitude of the 3ω voltage measured. The 3ω fit and the respective measurement sensitivities for the standard sample measurements are shown in FIGS. 5A-5D. For glass, the sample thermal conductivity is lower than the grease thermal conductivity; therefore, the measurement is not sensitive to the thermal paste thickness at all frequencies and is selectively sensitive to the glass thermal conductivity. For other samples whose thermal conductivity is greater than that of the thermal paste, at high frequencies (10 Hz-300 Hz), the 3ω measurement is selectively sensitive to the thermal properties of the thermal paste. With the thermal conductivity and the heat capacity of the thermal paste known, we fit the paste thickness to match the 3ω signal (both in-phase and out-of-phase) at high frequencies. At lower frequencies (˜0.1 Hz to 10 Hz), the 3ω measurement is sensitive to the sample thermal conductivity. With the paste thickness obtained from the high-frequency fit, the sample thermal conductivity is then obtained from the lower frequency 3ω fit (FIGS. 5A-5D).

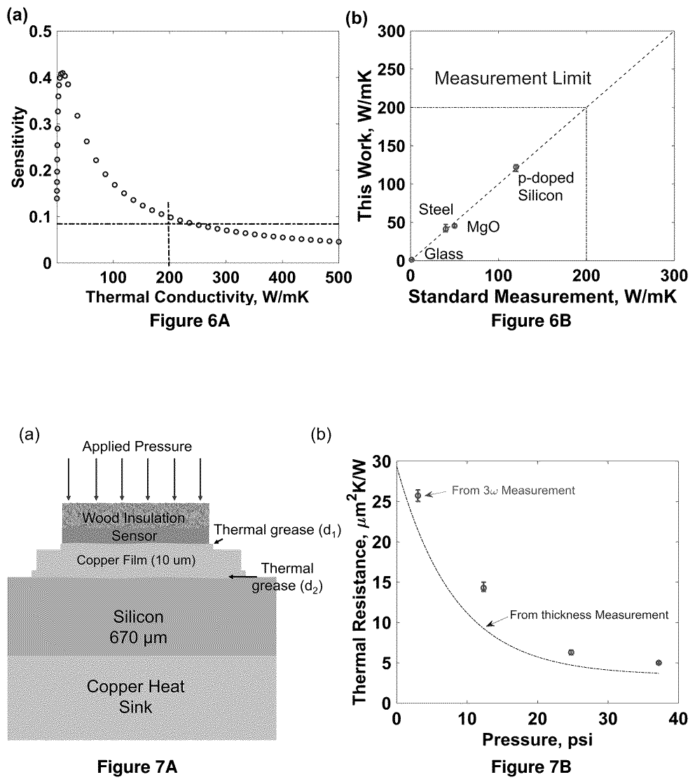

Even if small, the thermal paste presents an interfacial resistance that negatively affects the measurement sensitivity for high conductivity samples. Therefore, there is a need to establish the upper limit of thermal conductivity measurement with the proposed method. To do so, we set the thickness of the thermal paste to 50 μm and varied the sample thermal conductivity to determine the maximum sensitivity of the sample thermal conductivity within the frequency range of 100 mHz to 310 Hz. Within the frequency range, the maximum sensitivity as a function of the sample thermal conductivity is shown in FIG. 6A. When the sample thermal conductivity is small and comparable to that of the wooden insulation layer on top of the sensor (˜0.2 W/m−K), the heat loss to the insulation layer becomes important, and the measurement sensitivity is compromised. Therefore, we consider 1 W/m−K as the lower limit of the thermal conductivity measurement using this method. As the thermal conductivity increases, the absolute measurement sensitivity increases and reaches its maximum when the sample thermal conductivity is ˜5 W/m−K. Beyond that, the sensitivity decreases monotonically since the thermal paste resistance becomes dominant as the sample thermal resistance decreases. We chose a sensitivity of 0.1 to be the cut-off sensitivity for reasonable measurement accuracy as the 3ω measurement resolution for typical 3ω voltages (of the order of 10 s of μV) is only accurate enough to differentiate a 10% change in the signal (typically of the order of 1 μV). Below the cut-off sensitivity, a slight discrepancy in paste thermal resistance estimation can create a significant error in the measurement of the sample thermal conductivity. In FIG. 6A, the thermal conductivity corresponding to the maximum measurement sensitivity of 0.1 (or 10%) is ˜200 W/m−K. Therefore, we estimate the maximum thermal conductivity measurement limit to be 200 W/m−K for bulk thermal conductivity measurement using the proposed method. FIG. 6B summarizes the comparison of the standard bulk thermal conductivity measurements to the measurements using the proposed method, along with the measurement limit (200 W/m−K). In FIG. 6B, it is evident that the method can accurately measure the thermal conductivity of bulk samples within the measurement limit.

### EXAMPLE

### Buried Interlayer Thickness Measurement

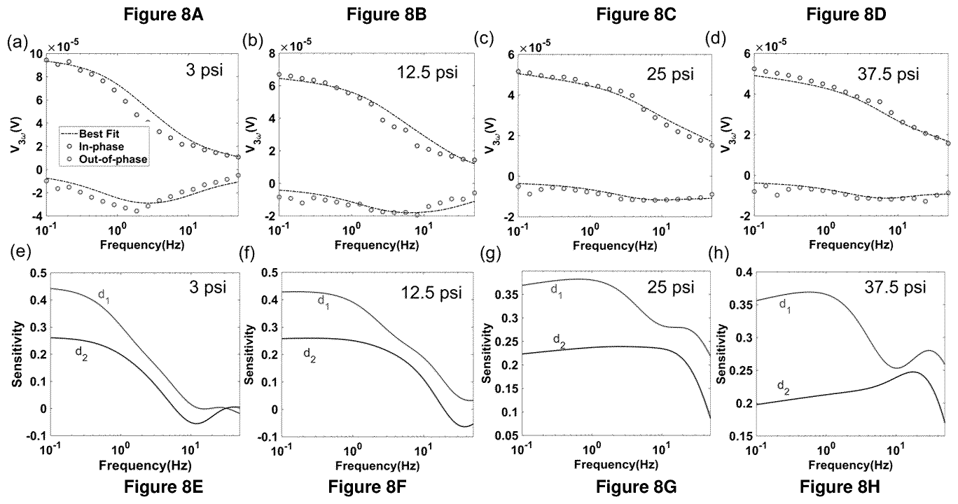

One of the advantages of the 3ω method compared to transient time-domain methods such as TPS or LFM is that the 3ω method can provide spatially resolved thermal information, which can be used to extract subsurface properties. To test the effectiveness of the proposed technique to extract subsurface information from the 3ω measurements, we created a silicon-copper stack (FIG. 7A) with an interlayer of the thermal paste to extract the thermal resistance of the interlayer thermal paste at different stack pressures from the 3ω measurements. We used the same thermal paste used at the sensor-sample interface since the paste thickness is well characterized from the micrometer-based measurement and can be used to directly verify the per unit area thermal resistance calculated from the thickness and thermal conductivity (7 W/m−K) using the equation Rᵢₙₜ=dᵢₙₜ/κᵢₙₜ, where Rᵢₙₜ is the thermal resistance of the interlayer, dᵢₙₜ is the interlayer thickness, and κᵢₙₜ is the interlayer thermal conductivity. This resistance can be directly compared to that extracted from the 3ω method. Because the thermal properties of copper and silicon are known, we fit the thickness of the thermal paste (d₂) between copper and the sensor and between silicon and copper to extract the buried interlayer thermal resistance, assuming a known thermal conductivity of 7 W/m−K for the thermal paste. FIGS. 8A-8D show the 3ω fits, and FIG. 8E-8H show the respective measurement sensitivities for the interlayer thickness measurements at 3 psi, 12.5 psi, 25 psi, and 37.5 psi, respectively. As the stack pressure increases, the paste thickness as well as the sensitivity to the first layer of the thermal paste decreases, because of which the measurement sensitivity to the second layer of the thermal paste, i.e., the interlayer thickness, increases. FIG. 7B compares the interlayer thermal resistance extracted from the 3ω measurement to the thermal resistance calculated from the thermal conductivity and the best-fit thickness measurement. The thermal resistance measured using the 3ω method is slightly higher but within the range of the thermal resistance calculated from the grease thickness measured using the micrometer. An offset between the 3ω measurement and the micrometer measurement can be seen, which we believe is caused by uneven pressing of the thermal grease between the copper foil and the silicon wafer, as compared to when pressed between two rigid silicon wafers in the case of the micrometer measurements. Nonetheless, the monotonic decrease in the thermal resistance as well as the saturation of the resistance beyond 30 psi pressure is well captured by the 3ω measurement.

### CONCLUSION

Further details regarding the embodiments described herein can be found in D. Chalise et al., High throughput, spatially resolved thermal properties measurement using attachable and reusable 3ω sensors,” Rev. Sci. Instrum. 94, 094901 (2023), which is hereby incorporated by reference.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A method comprising:
providing a sensor, the sensor comprising:
a polymer film, and
a metal line disposed on the polymer film, each end of the metal line being a contact pad;
depositing a thermal interface material on a first sample, the thermal interface material operable to decrease a contact resistance between the first sample and the sensor;
placing the sensor on the thermal interface material;
applying a pressure to the sensor; and
measuring, with the sensor, thermal conductivity of the first sample or thermal resistance of an interface between the first sample and a second sample using a 3 omega method.
The method of claim 1, wherein a lock-in amplifier and a current source are in contact with the contact pads to perform the 3 omega method.

2. The method of claim 1, wherein the polymer film is a polymer from a group polyimide, polyvinylidene fluoride (PVDF), polyethylene (PE), and polytetrafluoroethylene (PTFE).

3. The method of claim 1, wherein the polymer film is about 10 microns to 40 microns thick.

4. The method of claim 1, wherein the metal line is an alloy from a group chromium gold (Cr/Au), chromium silver (Cr/Ag), and chromium platinum (CR/Pt).

5. The method of claim 1, wherein the metal line is about 50 microns to 150 microns thick.

6. The method of claim 1, wherein the metal line is about 30 microns to 450 microns wide.

7. The method of claim 1, wherein the metal line comprises an elongated U-shape.

8. The method of claim 1, wherein the thermal interface material comprises a thermal paste or a thermal grease.

9. The method of claim 1, wherein a thermal conductivity of the thermal interface material is at least about 4 watts per meter Kelvin (W/m−K).

10. The method of claim 1, wherein the first sample is metal.

11. The method of claim 1, wherein the pressure is about 15 psi to 45 psi.

12. The method of claim 1, wherein after applying the pressure to the sensor, a thickness of the thermal interface material is substantially uniform.

13. The method of claim 1, wherein after applying the pressure to the sensor, a thickness of the thermal interface material is about 15 microns to 60 microns.

14. The method of claim 1, wherein measuring the thermal conductivity of the sample includes determining a thickness of the thermal interface material using the 3 omega method and then determining the thermal conductivity of the sample.

15. The method of claim 1, wherein the first sample is disposed on a second sample, wherein thermal conductivities of both the sample and the second sample are known, and wherein the thermal resistance of the interface between the first sample and the second sample is determined.

16. The method of claim 1, further comprising:
removing the sensor from the first sample;
depositing the thermal interface material on a third sample, the thermal interface material operable to decrease a contact resistance between the third sample and the sensor;
placing the sensor on the thermal interface material;
applying the pressure to the sensor; and
measuring. with the sensor, thermal conductivity of the third sample or thermal resistance of an interface between the third sample and a fourth sample using the 3 omega method.
